(19) United States
(12) Patent Application Publication
(10) Pub. No.: US 2013/0009064 A1
(43) Pub. Date: Jan. 10, 2013

(54) COINCIDENCE DETERMINATION METHOD AND APPARATUS OF PET DEVICE

(75) Inventors: Eiji Yoshida, Chiba-shi (JP); Taiga Yamaya, Chiba-shi (JP)

(73) Assignee: NATIONAL INSTITUTE OF RADIOLOGICAL SCIENCES, Chiba-shi, Chiba (JP)

(21) Appl. No.: 13/635,753

(22) PCT Filed: Mar. 25, 2010
(86) PCT No.: PCT/JP2010/055185

§ 371 Date: Sep. 18, 2012

(51) Int. Cl. G01T 1/164

(52) U.S. Cl. 250/362; 250/363.03

(57) ABSTRACT

In a coincidence determination processing of a PET device for regarding and counting a pair of annihilation radiations detected within a predetermined time as occurring from the same nuclide, a priority of a line of response to acquire is set and a true coincidence is extracted from multiple coincidences by using information on a detection time difference if a plurality of coincidences are detected with the predetermined time. Consequently, a true coincidence is extracted from multiple coincidences which have heretofore been discarded. This improves detection sensitivity at high radioactive concentration and contributes to an improved dynamic range.

### TECHNICAL FIELD

The present invention relates to a coincidence determination method and apparatus for a PET device, and more particularly to a coincidence determination method and apparatus for a PET device which can extract true coincidences from multiple coincidences which have heretofore been discarded, thereby improving detection sensitivity at high radioactive concentration and improving a dynamic range.

### BACKGROUND ART

As shown in FIG. 1, a coincidence method used by a PET device (Non-Patent Documents 1 and 2) is a detection method of regarding a pair of annihilation radiations 14 detected within an extremely short time of several nanoseconds as a true coincidence occurring from the same positron nuclide 12. In FIG. 1, 10 denotes a imaging target such as a patient; 20 denotes a detector ring (hereinafter, also referred to simply as ring) that constitutes the PET device and, for example, on the circumference of which a plurality of radiation detectors (hereinafter, also referred to simply as detectors) 22 are arranged; 24 denotes circuits that detect detected positions and time information of radiations in the detectors 22; 26 denotes a coincidence circuit that determines a coincidence to be present if a difference in detection time between a plurality of detectors 22 falls within a predetermined coincidence time width; and 28 denotes a data storage unit that stores coincidence data.

The time width for determining a positron nuclide (coincidence time width) is determined by the timing resolution and the size of the field of view of the PET device. At present, PET devices having an improved timing resolution of around 500 picoseconds are developed. The coincidence time width is also limited by the locations of positron nuclides and the ring diameter of the detectors to detect. A coincidence time width of around 4 nanoseconds or less will confine the imaging field of view of existing clinical PET devices.

As a PET device having extremely high timing resolution, a TOF-PET device has been developed which can improve the device sensitivity by limiting positions on a line of response, using information on a difference in time of flight (hereinafter, abbreviated as TOF) between a pair of annihilation radiations. With the current timing resolution of around 500 picoseconds, the device sensitivity has not been dramatically improved yet.

The coincidence method performs a positron nuclide determination in a finite time. A random coincidence such as shown in FIG. 2(A), resulting from the simultaneous detection of annihilation radiations from different positron nuclides, and a scatter coincidence such as shown in FIG. 2(B) can thus occur aside from a true coincidence shown in FIG. 1. Higher radioactive concentration increases the rate of random coincidences. As exemplified in FIG. 3, multiple coincidences resulting from the detection of a plurality of coincidences within a coincidence time width can also occur. FIG. 3(A) shows an example where two pairs of annihilation radiations (T₁, T₂) and (T₃, T₄) occur from two positron nuclides and three detectors detect the radiations within a coincidence time width. FIG. 3(B) shows an example where three pairs of annihilation radiations (T₁, T₂), (T₃, T₄), and (T₅, T₆) occur from three positron nuclides and three detectors detect the radiations within a coincidence time width. FIG. 3(C) shows an example where two pairs of annihilation radiations (T₁, T₂) and (T₃, T₄) occur from two positron nuclides and four detectors detect the radiations within a coincidence time width. FIG. 3(D) shows an example where three pairs of annihilation radiations (T₁, T₂), (T₃, T₄), and (T₅, T₅) occur from three positron nuclides and four detectors detect the radiations within a coincidence time width. In general, a PET device has a field of view in the center of its detector ring, and will not acquire lines of response that pass outside the field of view. In FIG. 3, coincidences between adjoining detectors are therefore invalidated. Consequently, the numbers of coincidence events detected in the examples of FIG. 3 are two in FIG. 3(A), two in FIG. 3(B), four in FIG. 3(C), and three in FIG. 3(D).

Multiple coincidence events may include true coincidences. With conventional PET devices, however, there has been no established technique for determination. As shown in FIG. 4, after coincidence determination (step 100), all the events have thus been discarded if it is determined that there are multiple coincidences with three or more detectors (step 110).

PET devices with improved sensitivity have recently been developed which have an increased ring length and a reduced ring diameter for close proximity imaging. In such devices, the probability of multiple coincidences is higher than in conventional PET devices.

A technology for identifying the incident directions of respective annihilation radiations to identify a true coincidence from multiple coincidences by using CZT detectors or the like having extremely high energy resolution and using the principle of a Compton camera has been under study (Patent Document 1 and Non-Patent Document 3).

According to such a method, true coincidences can be analytically extracted in principle. However, CZT detectors and the like have yet to be put to practical use as PET detectors, and can utilize only Compton scattering events inside the detectors. There has thus been a problem of rather limited event availability, i.e., low detector sensitivity.

### CITATION LIST

### Patent Literature

Patent Literature 1: Japanese Translation of International Patent Application No. 2008-522168

### Non-Patent Literature

Non-Patent Literature 1: H. M. Dent, W. F. Jones, and M. E. Casey, “A real time digital coincidence processor for positron emission tomography,” IEEE Trans. Nucl. Sci. Vol. 33, 556-559, 1986
Non-Patent Literature 2: D. F. Newport, H. M. Dent, M. E. Casey, and D. W. Bouldin, “Coincidence Detection and Selection in Positron Emission Tomography Using VLSI,” IEEE Trans. Nucl. Sci. Vol. 36, 1052-1055, 1989
Non-Patent Literature 3: G. Chinn, C. S. Levin, “A method to reject random coincidences and extract true from multiple coincidences in PET using 3-D detectors,” Nuclear Science Symposium Conference Record, 5249-5254, 2008.

### SUMMARY OF INVENTION

The coincidence determination method of the conventional PET device shown in FIG. 4 has not made efficient use of multiple coincidences resulting from the detection of a plurality of coincidences within a coincidence time width. Discarding all multiple coincidences lowers the detection sensitivity at high radioactive concentration, with a drop in image quality. Extremely high radioactive concentration increases the rate of multiple coincidences and contributes to a narrower dynamic range of the PET device. Multiple coincidences have quite complicated variations. Some multiple coincidences include only noise components such as a scatter coincidence and a random coincidence, and some involve the detection of three or more coincidences as exemplified in FIG. 3.

The present invention has been achieved in order to solve the foregoing conventional problem. It is thus an object thereof to extract a true coincidence from multiple coincidences which have heretofore been discarded, thereby improving detection sensitivity at high radioactive concentration and contributing to an improved dynamic range.

The present invention has been achieved in view of the fact that if there are lines of response detected as multiple coincidences, priorities can be set and a line of response to acquire can be determined by an extremely simple method based on the radioactivity distribution and information upon detection. The foregoing object has been achieved by the provision of a coincidence determination method of a PET device for regarding and counting a pair of annihilation radiations detected within a predetermined time as occurring from the same nuclide, the method including setting a priority of a line of response to acquire and extracting a true coincidence from multiple coincidences by using information on a detection time difference if a plurality of coincidences are detected with the predetermined time.

Here, a coincidence having the smallest detection time difference may be determined to be and extracted as a true coincidence from among the multiple coincidences.

Alternatively, a coincidence having a detection time difference smaller than a threshold may be determined to be and extracted as a true coincidence from among the multiple coincidences.

The threshold may be variable.

If there are a plurality of coincidences having a detection time difference smaller than the threshold, a single line of response the closest to a center of a field of view may be selected.

Alternatively, if there are a plurality of coincidences having a detection time difference smaller than the threshold, a single line of response having the highest total detected energy may be selected.

The present invention also provides a coincidence determination apparatus of a PET device, including:

a plurality of radiation detectors for detecting radiations occurring from a nuclide;

means for detecting detection times of radiations in the respective radiation detectors;

means for determining a coincidence to be present when a detection time difference between a plurality of the radiation detectors falls within a predetermined time; and

means for setting a priority of a line of response to acquire and extracting a true coincidence from multiple coincidences by using information on the detection time difference if a plurality of coincidences are detected with the predetermined time.

According to the present invention, true coincidences are extracted from multiple coincidences which have heretofore been discarded. This improves the detection sensitivity at high radioactive concentration and contributes to an improved dynamic range. The present invention is simply applicable to an existing PET device having high timing resolution, and is considered to be particularly effective for an ultra-high sensitivity PET device (such as a whole-body simultaneous imaging PET device) with a large ring length and a small ring diameter.

### BRIEF DESCRIPTION OF DRAWINGS

FIG. 1 is a diagram showing a conventional coincidence determination method.

FIG. 2(A) is a diagram showing an example of a random coincidence, and FIG. 2(B) is an example of a scatter coincidence.

FIG. 3 is a diagram showing examples of multiple coincidences.

FIG. 4 is a flowchart showing conventional coincidence determination processing.

FIG. 5 is a flowchart showing coincidence determination processing according to a first embodiment of the present invention.

FIG. 6 is a flowchart showing coincidence determination processing according to a second embodiment of the present invention.

FIG. 7 is a time chart showing an example of multiple coincidence determination according to the first and second embodiments.

FIG. 8 is a flowchart showing coincidence determination processing according to a third embodiment of the present invention.

FIG. 9 is a flowchart showing coincidence determination processing according to a fourth embodiment of the present invention.

FIG. 10 is a chart showing the result of a simulation of the relationship between radioactive concentration and the rate of multiple coincidences at each detector ring length.

FIG. 11 is a chart showing the result of a simulation of the relationship between radioactive concentration and the rate of true coincidences included in multiple coincidences at each detector ring length.

FIG. 12 is a chart showing the result of a simulation of the relationship between radioactive concentration and the rate of true coincidences with respect to each of multiple coincidence determination techniques.

FIG. 13 is a chart showing the result of a simulation of the relationship between radioactive concentration and the rate of random coincidences with respect to each of the multiple coincidence determination techniques.

FIG. 14 is a chart showing the result of a simulation of the relationship between radioactive concentration and a noise equivalent count rate NECR with respect to each of the multiple coincidence determination techniques.

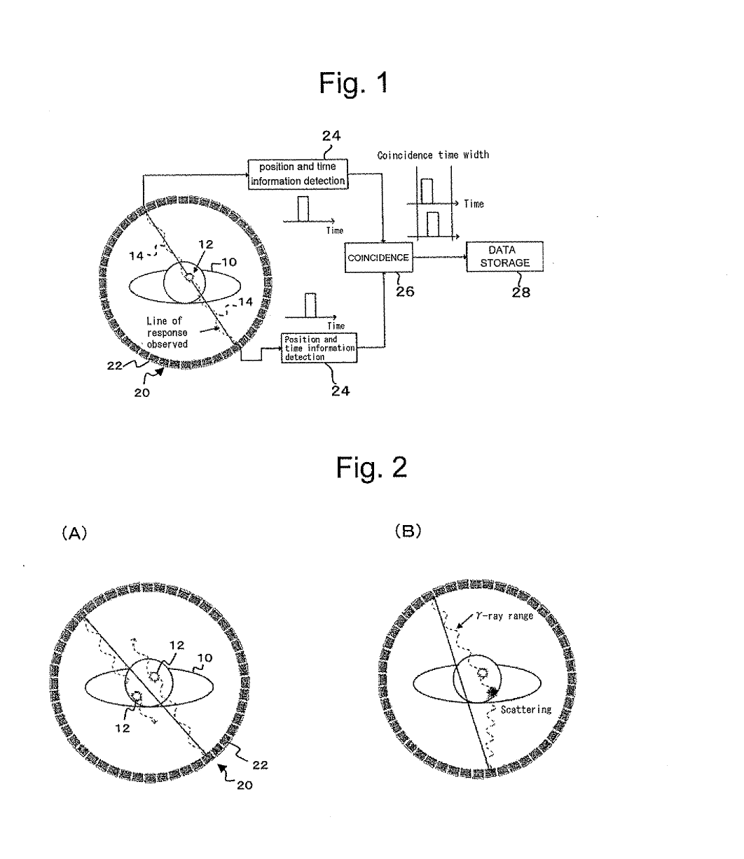

### DESCRIPTION OF EMBODIMENTS

Hereinafter, embodiments of the present invention will be described in detail with reference to the drawings.

A PET device typically images a subject in the center of its field of view. True coincidences therefore tend to be found near the center of the field of view, and random coincidences are uniformly found within the field of view. Most of noise components in multiple coincidences are considered to be random coincidences. Coincidences with a small detection time difference can thus be selected as true coincidences with high probability.

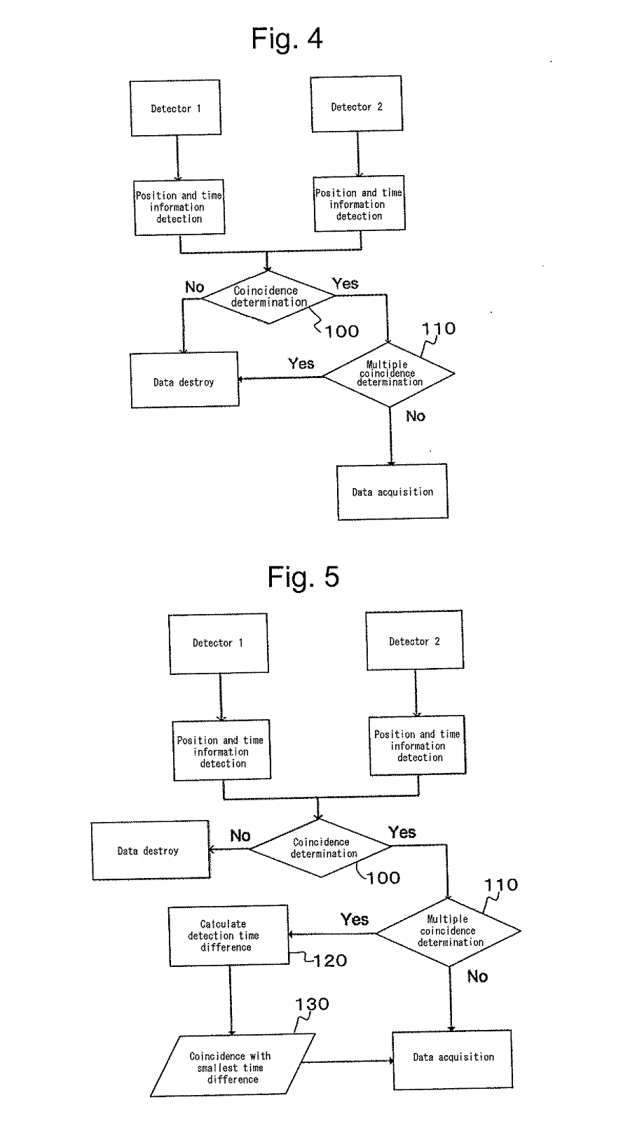

A first embodiment of the present invention has been achieved in view of the foregoing. As shown in FIG. 5, if multiple coincidences are determined to be present in the same step 110 as that of the conventional method of FIG. 4, all the coincidence events are passed to step 120 to calculate detection time differences. Next, in step 130, a coincidence having the smallest time difference is determined to be and extracted as a true coincidence.

The processing of the present embodiment is relatively simple.

Since multiple coincidences do not always include a true coincidence, the extraction of a single event from multiple coincidences all the time can cause an increase of noise components at high radioactivity.

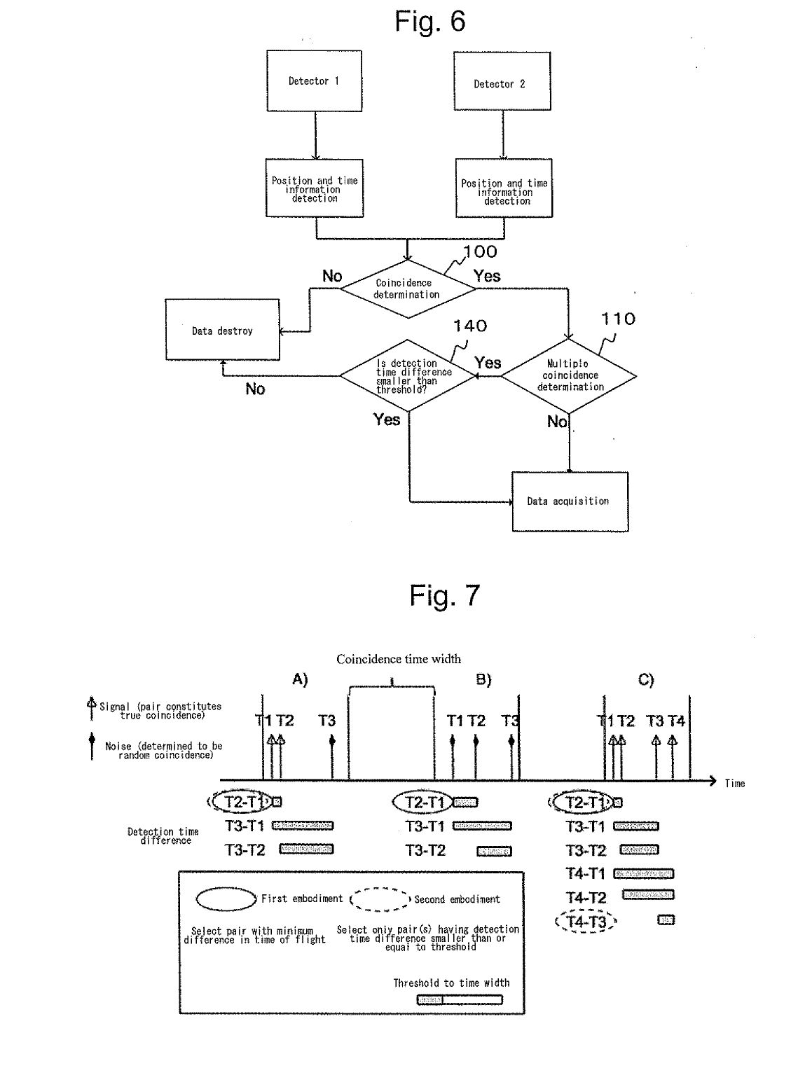

Then, in a second embodiment of the present invention, as shown in FIG. 6, if multiple coincidences are determined to be present in step 110, the processing proceeds to step 140. A line of response having a detection time difference smaller than a predetermined threshold is extracted to extract a true coincidence. Here, the predetermined threshold needs to be smaller than the coincidence time width of step 110. For example, the predetermined threshold may be set to ⅓ of the coincidence time width (for example, 6 nanoseconds), 2 nanoseconds, or may be made variable according to the count rate. For example, when the count rate is high, the threshold is made smaller than when the count rate is low. It should be appreciated that if the coincidence time width of step 110 is made as small as the threshold of step 140, it becomes not possible to detect annihilation radiations occurring from positions away from the center area of the detector ring. This undesirably narrows the field of view.

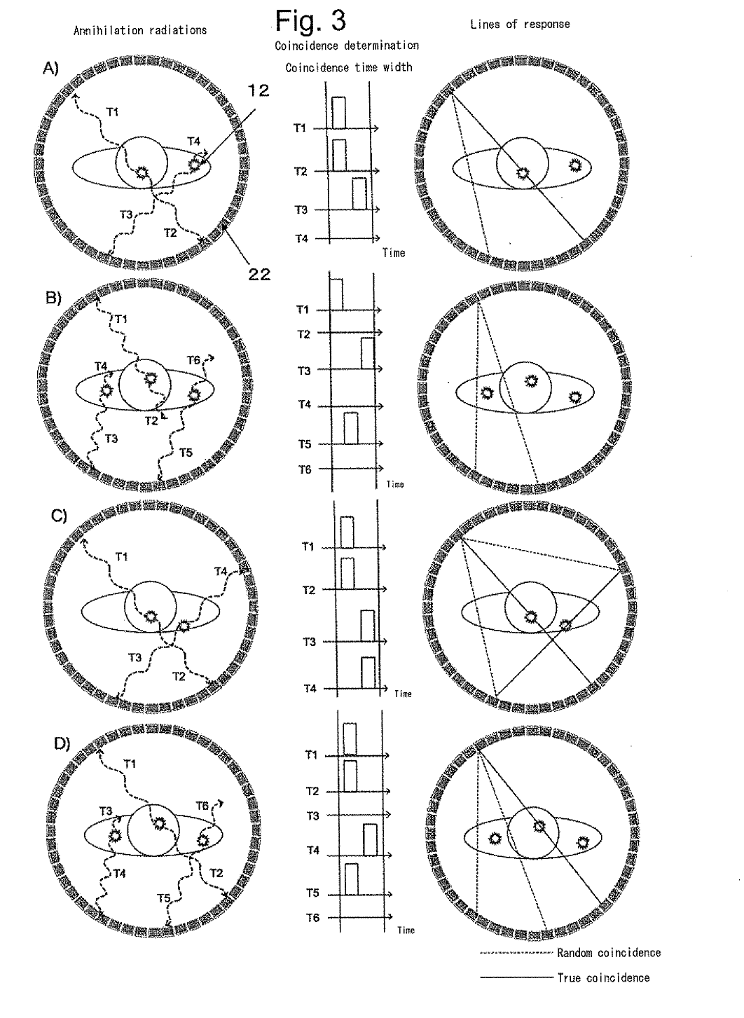

FIG. 7 shows an example where the first embodiment and the second embodiment are applied to the multiple coincidences of FIG. 3. In the case of FIG. 3(A) where a single true coincidence and a single random coincidence are included (before out-of-FOV determination), both the methods are likely to produce a right answer. Since the first embodiment always selects a single line of response, the first embodiment misjudges in the cases of FIG. 3(B) where no true coincidence is included and FIG. 3(C) where a plurality of true coincidences are included. On the other hand, the second embodiment has the possibility that a true coincidence(s) can be calculated even from the patterns of FIGS. 3(B) and 3(C).

In the second embodiment, the number of events to be determined is not limited to one. With practical radioactivity levels, a plurality of true coincidences are considered to be less likely to be detected among multiple coincidences. As shown in FIG. 3(D), a random coincidence with a detection time difference similar to that of a true coincidence is not identifiable.

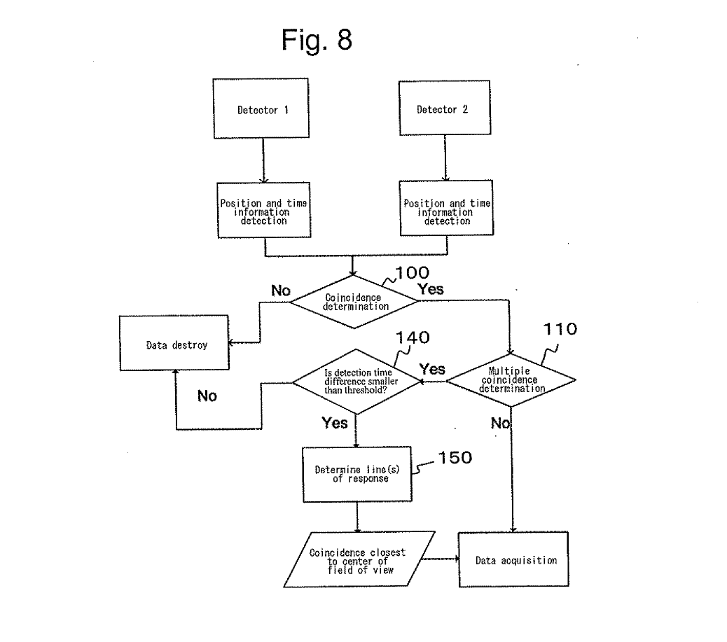

Then, like a third embodiment shown in FIG. 8, if a plurality of lines of response are calculated by the threshold determination of step 140, a single line of response the closest to the center of the field of view may be selected in step 150. This is considered to be able to increase the probability of extracting a true coincidence.

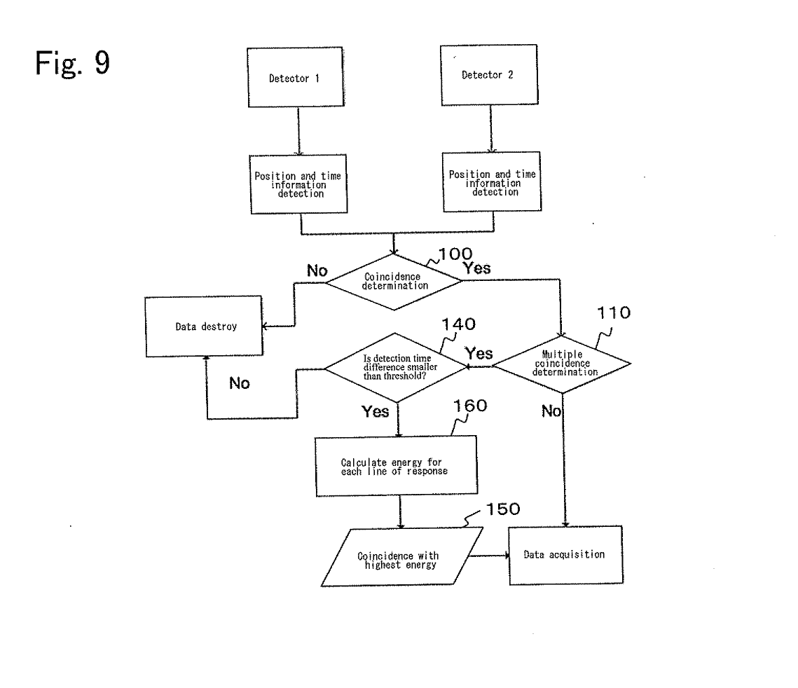

A true coincidence is likely to be detected with high energy as compared to a scatter coincidence shown in FIG. 2(B). Thus, like a fourth embodiment shown in FIG. 9, if a plurality of lines of response are calculated by the threshold determination of step 140, the energy of each of the lines of response may be calculated in step 160 and a single line of response having the highest detected energy may be selected in step 170. This is considered to be able to increase the probability of extracting a true coincidence.

### Examples

A simulation of a whole-body simultaneous imaging PET device was performed. The device used block detectors including an array of 2.9×2.9×20-mm-thick LSO scintillators to constitute a detector ring having a ring diameter of 84 cm. Three types of detector rings having a ring length of 64 cm, 15 cm, and 130 cm in the direction of the body axis were simulated. A cylindrical phantom of 20 cm in diameter and 1 m in length was placed in the ring center. The detectors had a timing resolution of 600 picoseconds and a coincidence time width of 6 nanoseconds.

FIG. 10 shows the rates of multiple coincidences in the PET devices with the three types of ring lengths 64 cm, 15 cm, and 130 cm at various radioactivities. The rates of multiple coincidences increase as the radioactivity and the ring length increase.

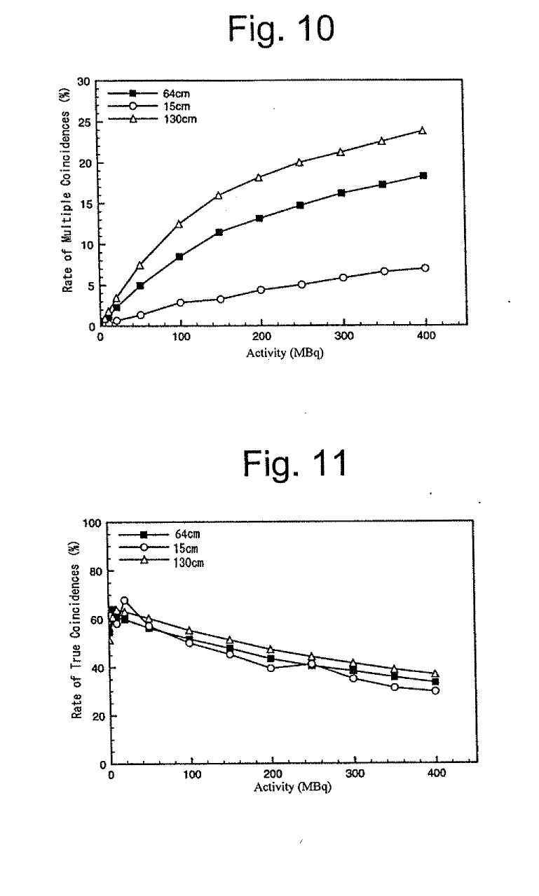

FIG. 11 shows the rates of true coincidences included in multiple coincidences. The rates of true coincidences included depend not much on the ring length and decrease depending on the radioactivity.

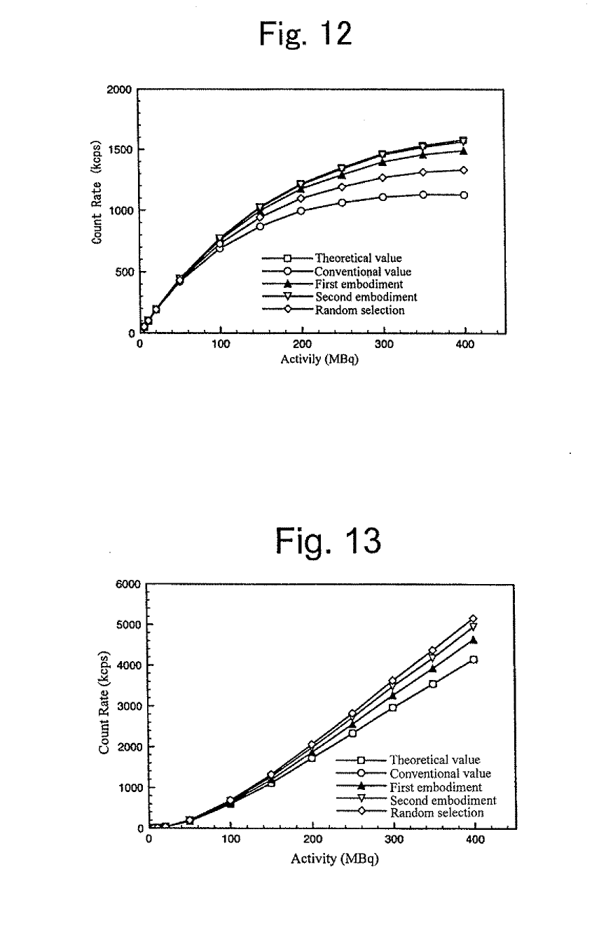

FIGS. 12 and 13 show the rates of true coincidences and those of random coincidences in the device of 64 cm in ring length when several techniques for multiple coincidence determination were applied. The threshold according to the second embodiment, i.e., the second coincidence time width was 2 nanoseconds. Random selection, which was employed as a comparative method, includes selecting a single line of response at random from multiple coincidence events.

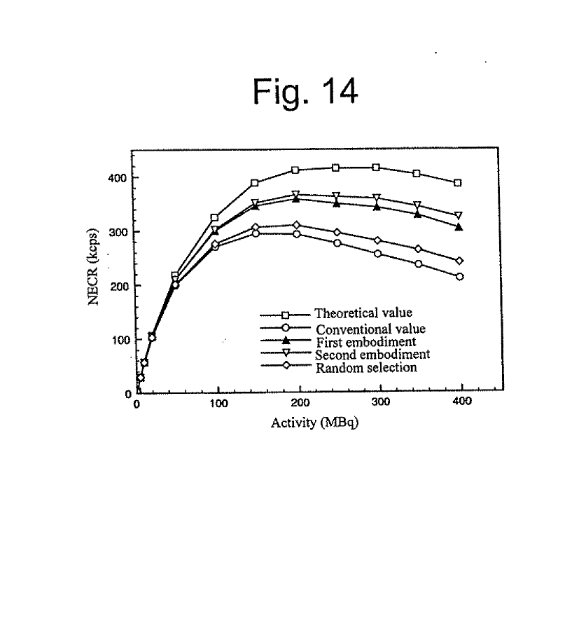

FIG. 14 shows noise equivalent count rate (NECR) when the several techniques for multiple coincidence determination were applied.

NECR is an index for evaluating the effective count characteristics of a cylindrical phantom in consideration of the ratio of apparent noise components such as random coincidences. NECR, frequently used to evaluate the performance of a PET device, is expressed by the following equation (see S. C. Strother, M. E. Casey, E. J. Hoffman, IEEE Trans. Nucl. Sci., vol. 37, 783-788, 1990):

NECR=T²/(T+S+R)

Here, T is the rate of true coincidences, S is the rate of scatter coincidences, and R is the rate of random coincidences. The result suggests that the application of the present invention provides an improvement of around 20% in image quality. An improvement effect superior to the case of extracting true coincidences at random (random select) was also observed.

### INDUSTRIAL APPLICABILITY

At present, high sensitivity PET devices are being developed like a close proximity imaging PET device. Since the coincidence time width is limited by detector arrangement, the effect of multiple coincidences is considered to increase. The method for determining multiple coincidences can thus be an essential element technology for achieving an ultra-high sensitivity PET device.

### REFERENCE SIGNS LIST

10 . . . imaging target
12 . . . positron nuclide
20 . . . detector ring
22 . . . radiation detector
24 . . . circuit for detecting position and time information
26 . . . coincidence circuit
28 . . . data storage

1. A coincidence determination method of a PET device for regarding and counting a pair of annihilation radiations detected within a predetermined time as occurring from the same nuclide,
the method comprising: setting a priority of a line of response to acquire and extracting a true coincidence from multiple coincidences by using information on a detection time difference if a plurality of coincidences are detected with the predetermined time.

2. The coincidence determination method of a PET device according to claim 1, wherein a coincidence having the smallest detection time difference is determined to be and extracted as a true coincidence from among the multiple coincidences.

3. The coincidence determination method of a PET device according to claim 1, wherein a coincidence having a detection time difference smaller than a threshold is determined to be and extracted as a true coincidence from among the multiple coincidences.

4. The coincidence determination method of a PET device according to claim 3, wherein the threshold is variable.

5. The coincidence determination method of a PET device according to claim 3, wherein if there are a plurality of coincidences having a detection time difference smaller than the threshold, a single line of response the closest to a center of a field of view is selected.

6. The coincidence determination method of a PET device according to claim 3, wherein if there are a plurality of coincidences having a detection time difference smaller than the threshold, a single line of response having the highest total detected energy of a pair of annihilation radiations is selected.

7. A coincidence determination apparatus of a PET device, comprising:
a plurality of radiation detectors for detecting radiations occurring from a nuclide;
means for detecting detection times of radiations in the respective radiation detectors;
means for determining a coincidence to be present when a detection time difference between a plurality of the radiation detectors falls within a predetermined time; and
means for setting a priority of a line of response to acquire and extracting a true coincidence from multiple coincidences by using information on the detection time difference if a plurality of coincidences are detected with the predetermined time.

8. The coincidence determination apparatus of a PET device according to claim 7, wherein a coincidence having the smallest detection time difference is determined to be and extracted as a true coincidence from among the multiple coincidences.

9. The coincidence determination apparatus of a PET device according to claim 8, wherein a coincidence having a detection time difference smaller than a threshold is determined to be and extracted as a true coincidence from among the multiple coincidences.

10. The coincidence determination apparatus of a PET device according to claim 9, wherein the threshold is variable.

11. The coincidence determination apparatus of a PET device according to claim 9, wherein if there are a plurality of coincidences having a detection time difference smaller than the threshold, a single line of response the closest to a center of a field of view is selected.

12. The coincidence determination apparatus of a PET device according to claim 9, wherein if there are a plurality of coincidences having a detection time difference smaller than the threshold, a single line of response having the highest total detected energy of a pair of annihilation radiations is selected.
